(19) United States
(12) Patent Application Publication
(10) Pub. No.: US 2016/0216546 A1
(43) Pub. Date: Jul. 28, 2016

(54) DISPLAY DEVICE AND MANUFACTURING METHOD THEREOF

(71) Applicant: Samsung Display Co., Ltd, Yongin-si (KR)

(72) Inventors: Min Su KIM, Seoul (KR); Si Kwang KIM, Daegu (KR); Tae Woon CHA, Seoul (KR); Seung-Yeon CHAE, Hwaseong-si (KR)

(21) Appl. No.: 14/966,830

(22) Filed: Dec. 11, 2015

(30) Foreign Application Priority Data
Jan. 26, 2015 (KR) 10-2015-0012141

(51) Int. Cl. G02F 1/1339; G02F 1/1341; G02F 1/1335; G02F 1/1343; G02F 1/1368; G02F 1/1333

(52) U.S. Cl. CPC G02F 1/13394; G02F 1/1368; G02F 1/133377; G02F 1/133514; G02F 1/133512; G02F 1/13439; G02F 1/133516; G02F 1/1341

(57) ABSTRACT

Provided is a display device including: a substrate; a plurality of thin film transistors positioned on the substrate; a plurality of pixel electrodes connected with one terminal of the thin film transistor; a plurality of partition walls formed between the plurality of pixel electrodes; a liquid crystal material positioned in a microcavity between adjacent partition walls; a common electrode positioned on the partition wall and the liquid crystal material; and a color filter layer formed on the common electrode, in which the partition wall is a photoresist.

### CROSS-REFERENCE TO RELATED APPLICATION

This application claims priority to and the benefit of Korean Patent Application No. 10-2015-0012141 filed in the Korean Intellectual Property Office on Jan. 26, 2015, the entire contents of which are incorporated herein by reference.

### BACKGROUND

(a) Field

The present disclosure relates to a display device and a manufacturing method thereof.

(b) Description of the Related Art

A liquid crystal display is a type of flat panel display that is currently in use and generally includes two display panels with field generating electrodes, such as a pixel electrode and a common electrode, and a liquid crystal layer interposed therebetween. The liquid crystal display generates an electric field in the liquid crystal layer by applying a voltage to the field generating electrodes. The generated electric field determines the alignment of liquid crystal molecules of the liquid crystal layer and thereby determines the polarization of incident light by the liquid crystal layer. Thus, by controlling the generated electric field, the control polarization of incident light may be controlled to display images.

The two display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. In the opposing display panel, a light blocking member, a color filter, a common electrode, and the like may be formed. In some cases, the light blocking member, the color filter, and the common electrode may be formed on the thin film transistor array panel.

However, because two substrates are necessarily used in a liquid crystal display in the related art, and respective constituent elements are formed on the two substrates, the display device is heavy and thick, has a high cost, and has a long processing time.

The above information disclosed in this Background section is only for enhancement of understanding of the background of the disclosure and therefore may contain information that does not form the prior art that is already known in this country to a person of ordinary skill in the art.

### SUMMARY

The present disclosure provides a display device and a manufacturing method thereof having advantages of reduced weight, thickness, cost, and processing time by manufacturing the display device by using one substrate.

The present disclosure also provides a display device and a manufacturing method thereof having advantages of ensuring structural stability by forming a partition wall so as to prevent a color filter layer forming a microcavity from sagging.

An exemplary embodiment of the present disclosure provides a display device including: a substrate; a plurality of thin film transistors positioned on the substrate; a plurality of pixel electrodes connected with one terminal of the thin film transistor; a plurality of partition walls formed between the plurality of pixel electrodes; a liquid crystal material positioned in a microcavity between adjacent partition walls; a common electrode positioned on the partition wall and the liquid crystal material; and a color filter layer formed on the common electrode, in which the partition wall is a photoresist.

The partition wall may be a cured negative photoresist.

A plurality of microcavities may be arranged in a matrix form on the substrate, and the plurality of microcavities may be spaced apart from each other with a first valley formed in an extending direction of the gate line and a second valley formed in an extending direction of the data line therebetween.

The partition wall may fill the second valley.

The partition wall may not be formed in the first valley.

A thin film transistor and a light-blocking black matrix may be formed in the first valley.

A color filter layer may be positioned on the partition wall.

Two color filters having different colors may be formed to be adjacent to each other on the partition wall.

The height of the partition wall may be the same as that of the microcavity.

A common electrode may be formed below the color filter layer, and the common electrode may be spaced apart from the pixel electrode with the microcavity therebetween.

Another exemplary embodiment of the present disclosure provides a method for manufacturing a display device including: forming a thin film transistor on a substrate; forming a first insulating layer on the thin film transistor; forming a pixel electrode connected with the thin film transistor on the first insulating layer; forming a sacrificial layer by coating a photoresist on the pixel electrode; curing a partial region of the sacrificial layer by positioning and exposing a mask on the sacrificial layer; forming a color filter layer on the sacrificial layer; forming a liquid crystal injection hole and exposing the sacrificial layer by patterning the color filter layer; forming a microcavity between the pixel electrode and the color filter layer by removing the sacrificial layer; forming an alignment layer by injecting an alignment layer material into the microcavity; forming a liquid crystal layer by injecting a liquid crystal material into the microcavity; and sealing the microcavity by forming an overcoat on the color filter layer.

The photoresist used in the forming of the sacrificial layer by coating the photoresist on the pixel electrode may be a negative photoresist.

In the curing the partial region of the sacrificial layer by positioning and exposing the mask on the sacrificial layer, the negative photoresist may be cured to form the partition wall.

A plurality of microcavities may be arranged in a matrix form on the substrate, and the plurality of microcavities may be spaced apart from each other with a first valley formed in an extending direction of the gate line and a second valley formed in an extending direction of the data line therebetween.

The partition wall may fill the second valley.

In the forming the microcavity between the pixel electrode and the color filter layer by removing the sacrificial layer, the partial region of the sacrificial layer may not be removed and may remain as the partition wall.

Between the curing of the partial region of the sacrificial layer by positioning and exposing the mask on the sacrificial layer and the forming of the color filter layer on the sacrificial layer, the method may further include forming a common electrode on the sacrificial layer.

As described above, the display device and the manufacturing method thereof according to exemplary embodiments of the present disclosure have the following effects.

According to exemplary embodiment of the present disclosure, it is possible to reduce the weight, thickness, costs, and processing time of a display device by manufacturing the display device using one substrate.

Further, it is possible to prevent a structure, such as a color filter positioned on the microcavity, from sagging and induce agglomeration of the alignment layer into a connection microcavity by connecting the microcavities adjacent in the column direction of each pixel area using a connection microcavity.

### BRIEF DESCRIPTION OF THE DRAWINGS

FIG. 1 is a plan view illustrating a display device according to an exemplary embodiment of the present disclosure.

FIG. 2 is a plan view illustrating one pixel in the display device according to an exemplary embodiment of the present disclosure.

FIG. 3 is a cross-sectional view illustrating a part of the display device of FIG. 1 taken along line according to an exemplary embodiment of the present disclosure.

FIG. 4 is a cross-sectional view illustrating a part of the display device of FIG. 1 taken along line IV-IV according to an exemplary embodiment of the present disclosure.

FIGS. 5, 6, 7, 8, 9, 10, 11, 12, 13, 14, 15, 16, 17, 18, 19, 20, 21, 22, 23, 24 and 25 are process cross-sectional views illustrating a manufacturing process of the display device according to an exemplary embodiment of the present disclosure.

### DETAILED DESCRIPTION OF THE EMBODIMENTS

The present system and method are described more fully hereinafter with reference to the accompanying drawings in which exemplary embodiments of the system and method are shown. As those of ordinary skill in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element, or intervening elements may also be present. In contrast, when an element is referred to as being “directly on” another element, there are no intervening elements present.

Hereinafter, a display device according to an exemplary embodiment of the present disclosure is schematically described below.

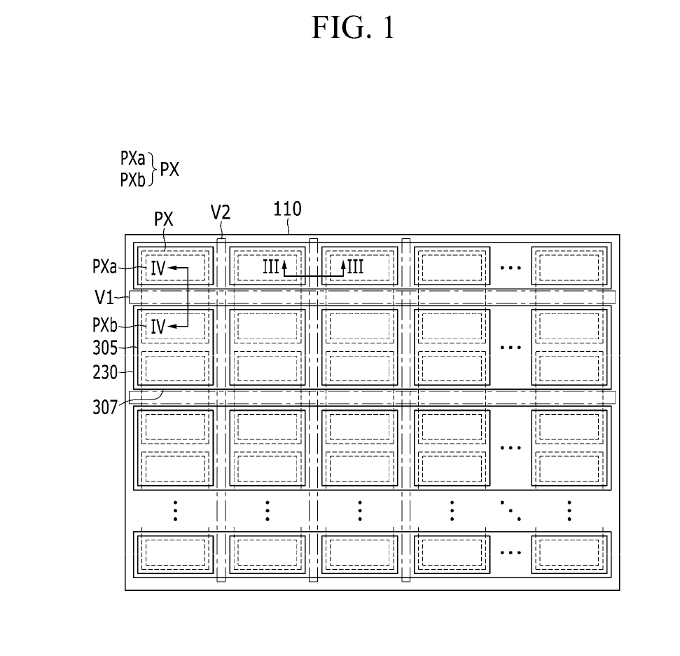

FIG. 1 is a plan view illustrating a display device according to an exemplary embodiment of the present disclosure, and for convenience, FIG. 1 illustrates only some constituent elements. The display device includes a substrate 110 made of a material, such as glass or plastic, and a color filter layer 230 formed on the substrate 110.

The substrate 110 includes a plurality of pixels PX. The plurality of pixel areas PX is disposed in a matrix form that includes a plurality of pixel rows and a plurality of pixel columns. Each pixel area PX may include a first subpixel area PXa and a second subpixel area PXb. The first subpixel area PXa and the second subpixel area PXb may be vertically disposed.

A first valley V1 is positioned between the first subpixel area PXa and the second subpixel area PXb in a pixel row direction, and a second valley V2 is positioned between the plurality of pixel columns.

Such a first valley is also called a transistor region where a transistor of the pixel and the like are formed. Further, the second valley is called a partition wall formation region where a partition wall between adjacent pixels is formed.

The color filter layer 230 is formed in a pixel row direction. In this case, in the first valley V1, the color filter layer 230 is removed to form an injection hole 307 so that constituent elements positioned below the color filter layer 230 are exposed to the outside.

Each color filter layer 230 is formed to be separated from the substrate 110 between adjacent second valleys V2 to form a microcavity 305. Further, each color filter layer 230 is formed to be attached onto the substrate 110 at the second valley V2 to cover both sides of the microcavity 305.

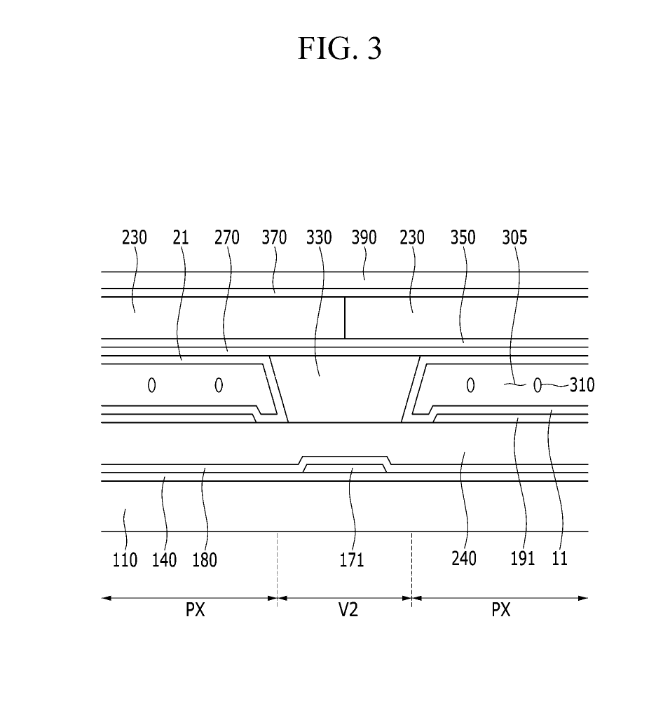

In more detail, the color filter layer 230 is supported by a partition wall 330 (see FIG. 3) on the substrate 110 in the second valley V2, which is further described below.

The structure of the display device according to the exemplary embodiment of the present disclosure described above is just an example, and may be variously modified. For example, the layout form of the pixel area PX, the first valleys V1, and the second valleys V2 may be modified; the plurality of color filter layers 230 may be connected to each other in the first valleys V1; and a part of each color filter layer 230 may be separated from the substrate 110 in the second valley V2 such that the adjacent microcavities 305 may be connected to each other.

Next, one pixel of the display device according to an exemplary embodiment of the present disclosure is described below with reference to FIGS. 1 to 4.

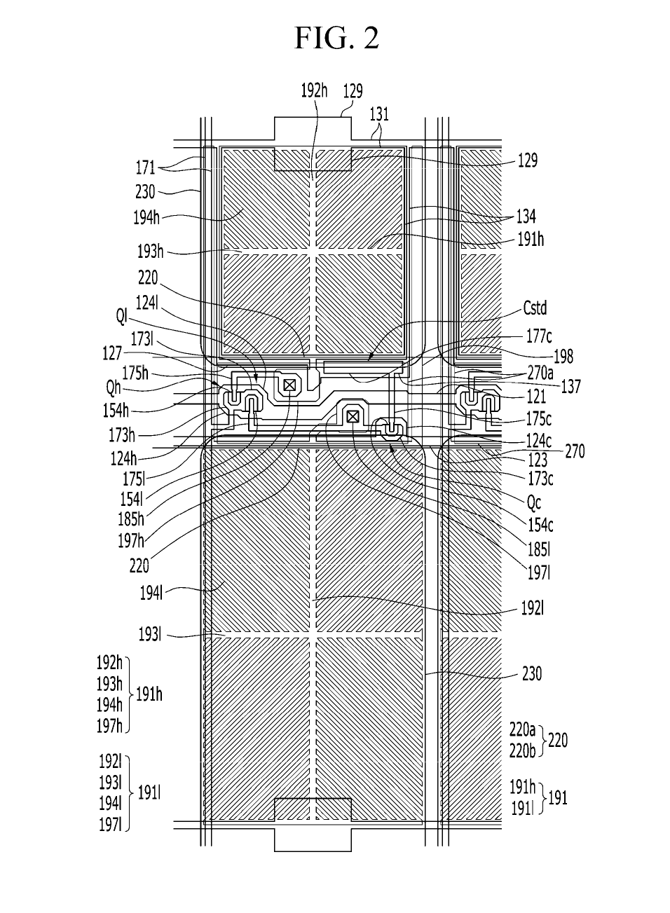

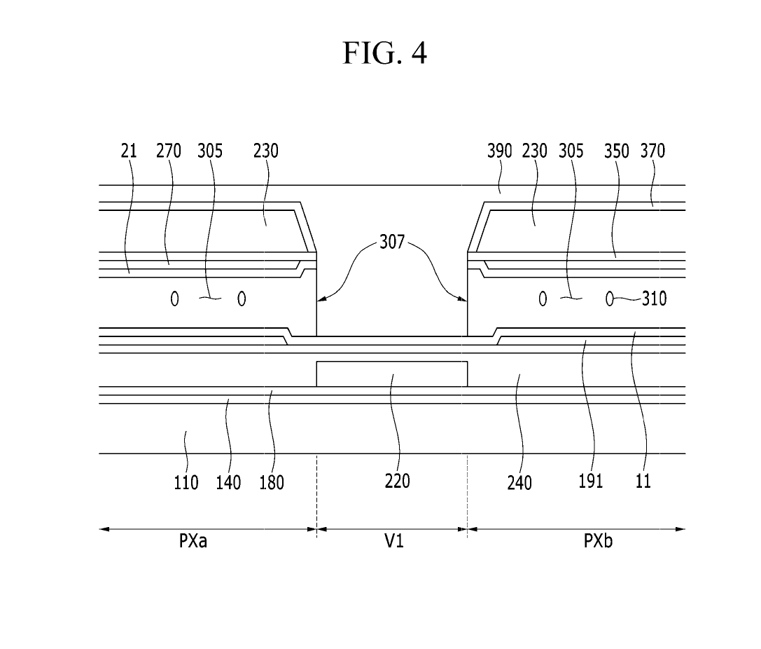

FIG. 2 is a plan view illustrating one pixel of the display device according to an exemplary embodiment of the present disclosure. FIG. 3 is a cross-sectional view illustrating a part of the display device taken along line of FIG. 1 according to an exemplary embodiment of the present disclosure. FIG. 4 is a cross-sectional view illustrating a part of the display device taken along line IV-IV of FIG. 1 according to an exemplary embodiment of the present disclosure.

Referring to FIGS. 1 to 4, a plurality of gate conductors including a plurality of gate lines 121, a plurality of step-down gate lines 123, and a plurality of storage electrode lines 131 is formed on the substrate 110.

The gate line 121 and the step-down gate line 123 mainly extend in a horizontal direction to transfer gate signals. The gate conductor further includes a first gate electrode 124h and a second gate electrode 124l protruding upward and downward from the gate line 121, and further includes a third gate electrode 124c protruding upward from the step-down gate line 123. The first gate electrode 124h and the second gate electrode 124l are connected with each other to form one protrusion. In this case, the protrusion form of the first, second, and third gate electrodes 124h, 124l, and 124c may be modified.

The storage electrode line 131 mainly extends in a horizontal direction and transfers a predetermined voltage such as a common voltage Vcom. The storage electrode line 131 includes storage electrodes 129 protruding upward and downward, a pair of vertical portions 134 extending downward to be substantially vertical to the gate line 121, and a horizontal portion 127 connecting ends of the pair of vertical portions 134. The horizontal portion 127 includes a capacitor electrode 137 that extends downward.

A gate insulating layer 140 is positioned on the gate conductors 121, 123, 124h, 124l, 124c, and 131. The gate insulating layer 140 may be made of an inorganic insulating material such as silicon nitride (SiNx) and silicon oxide (SiOx). Further, the gate insulating layer 140 may be formed as a single layer or multilayers.

A first semiconductor 154h, a second semiconductor 154l, and a third semiconductor 154c are formed on the gate insulating layer 140. The first semiconductor 154h may be positioned on the first gate electrode 124h, the second semiconductor 154l may be positioned on the second gate electrode 124l, and the third semiconductor 154c may be positioned on the third gate electrode 124c. The first semiconductor 154h and the second semiconductor 154l may be connected to each other, and the second semiconductor 154l and the third semiconductor 154c may also be connected to each other. Further, the first semiconductor 154h may extend to the lower portion of the data line 171. The first to third semiconductors 154h, 154l, and 154c may be made of amorphous silicon, polycrystalline silicon, metal oxide, and the like.

Ohmic contacts (not illustrated) may be further positioned on the first to third semiconductors 154h, 154l, and 154c, respectively. The ohmic contact may be made of silicide or a material such as n+ hydrogenated amorphous silicon in which an n-type impurity is doped at a high concentration.

Data conductors including a data line 171, a first source electrode 173h, a second source electrode 173l, a third source electrode 173c, a first drain electrode 175h, a second drain electrode 175l, and a third drain electrode 175c are formed on the first to third semiconductors 154h, 154l, and 154c.

The data lines 171 transfer data signals and mainly extend in a vertical direction to cross the gate lines 121 and the step-down gate lines 123. Each data line 171 includes a first source electrode 173h and a second source electrode 173l which extend toward the first gate electrode 124h and the second gate electrode 124l and are connected to each other.

Each of the first drain electrode 175h, the second drain electrode 175l, and the third drain electrode 175c includes a wide end portion and a rod-shaped end portion. The rod-shaped end portions of the first drain electrode 175h and the second drain electrode 175l are partially surrounded by the first source electrode 173h and the second source electrode 173l. The wide end portion of the second drain electrode 175l is again extended to form a third source electrode 173c that is bent in a ‘U’-lettered shape. The wide end portion 177c of the third drain electrode 175c overlaps with the capacitive electrode 137 to form a step-down capacitor Cstd, and the rod-shaped end portion is partially surrounded by the third source electrode 173c.

The first gate electrode 124h, the first source electrode 173h, and the first drain electrode 175h form a first thin film transistor Qh together with the first semiconductor 154h. The second gate electrode 124l, the second source electrode 173l, and the second drain electrode 175l form a second thin film transistor Ql together with the second semiconductor 154l. The third gate electrode 124c, the third source electrode 173c, and the third drain electrode 175c form the third thin film transistor Qc together with the third semiconductor 154c.

The first semiconductor 154h, the second semiconductor 154l, and the third semiconductor 154c are connected to each other to form a stripe shape, and may have substantially the same planar shape as the data conductors 171, 173h, 173l, 173c, 175h, 175l, and 175c, and the ohmic contacts therebelow, except for channel regions between the source electrodes 173h, 173l, and 173c and the drain electrodes 175h, 175l, and 175c.

In the first semiconductor 154h, an exposed portion that is not covered by the first source electrode 173h and the first drain electrode 175h is disposed between the first source electrode 173h and the first drain electrode 175h. In the second semiconductor 154l, an exposed portion that is not covered by the second source electrode 173l and the second drain electrode 175l is disposed between the second source electrode 173l and the second drain electrode 175l. In addition, in the third semiconductor 154c, an exposed portion that is not covered by the third source electrode 173c and the third drain electrode 175c is disposed between the third source electrode 173c and the third drain electrode 175c.

A passivation layer 180 is formed on the data conductors 171, 173h, 173l, 173c, 175h, 175l, and 175c and the semiconductors 154h, 154l, and 154c exposed between the respective source electrodes 173h/173l/173c and the respective drain electrodes 175h/175l/175c. The passivation layer 180 may be made of an organic insulating material or an inorganic insulating material, and may be formed as a single layer or multilayers.

A light blocking member 220 is formed on the passivation layer 180. The light blocking member 220 is formed on a boundary of the pixel area PX and the thin film transistor to prevent light leakage. That is, the light blocking member 220 is formed between the first subpixel area PXa and the second subpixel area PXb.

The light blocking member 220 extends along the gate line 121 and the step-down gate line 123 to be extended upward and downward, and covers a region in which the first thin film transistor Qh, the second thin film transistor Ql, and the third thin film transistor Qc are positioned.

The light blocking member 220 may be formed only in the first valley V1 and not in the second valley. The partition wall 330 and the color filter 230 are formed on the second valley to block the light of the data line 171, which is further described below. Accordingly, a separate light blocking member 220 is not required.

A first insulating layer 240 may be further formed on the light blocking member 220. The first insulating layer 240 may be made of an inorganic insulating material such as silicon nitride (SiNx), silicon oxide (SiOx), and silicon oxynitride (SiOxNy). The first insulating layer 240 serves to protect the light blocking member 220 made of an organic material, and may be omitted in some cases.

In the first insulating layer 240, the light blocking member 220, and the passivation layer 180, a plurality of first contact holes 185h and a plurality of second contact holes 185l, which expose the wide end portion of the first drain electrode 175h and the wide end portion of the second drain electrode 175l, respectively, are formed.

A pixel electrode 191 is formed on the first insulating layer 240. The pixel electrode 191 may be made of a transparent metal material such as indium tin oxide (ITO) and indium zinc oxide (IZO).

The pixel electrode 191 includes a first subpixel electrode 191h and a second subpixel electrode 191l that are separated from each other with the gate line 121 and the step-down gate line 123 therebetween and respectively disposed in the pixel area PX above and below the gate line 121 and the step-down gate line 123 to be adjacent to each other in a column direction. That is, the first subpixel electrode 191h and the second subpixel electrode 191l are separated from each other with the first valley V1 therebetween, the first subpixel electrode 191h is positioned in the first subpixel area PXa, and the second subpixel electrode 191l is positioned in the second subpixel area PXb.

The first subpixel electrode 191h and the second subpixel electrode 191l are connected with the first drain electrode 175h and the second drain electrode 175l through the first contact hole 185h and the second contact hole 185l, respectively. Accordingly, when the first thin film transistor Qh and the second thin film transistor Ql are turned on, the first subpixel electrode 191h and the second subpixel electrode 191l receive data voltages from the first drain electrode 175h and the second drain electrode 175l.

An overall shape of each of the first subpixel electrode 191h and the second subpixel electrode 191l is a quadrangle. The first subpixel electrode 191h and the second subpixel electrode 191l include cross stems including horizontal stems 193h and 193l and vertical stems 192h and 192l crossing the horizontal stems 193h and 193l, respectively. Further, the first subpixel electrode 191h and the second subpixel electrode 191l include a plurality of minute branches 194h and 194l, and protrusions 197h and 197l protruding downward and upward from edge sides of the subpixel electrodes 191h and 191l, respectively.

Each of the subpixel electrodes 191h and 191l is divided into four domains by the horizontal stems 193h and 193l and the vertical stems 192h and 192l, respectively. The minute branches 194h and 194l obliquely extend from the horizontal stems 193h and 193l and the vertical stems 192h and 192l at an angle of approximately 45° or 135° with the gate line 121 or the horizontal stems 193h and 193l. Further, extending directions of the minute branches 194h and 194l of two adjacent domains may be orthogonal to each other.

In an exemplary embodiment, the first subpixel electrode 191h further includes an outer stem along its boundary, and the second subpixel electrode 191l further includes horizontal portions positioned at an upper end and a lower end, and left and right vertical portions 198 positioned at the left and the right of the first subpixel electrode 191h. The left and right vertical portions 198 may prevent capacitive coupling, that is, coupling between the data line 171 and the first subpixel electrode 191h. However, the outer stem may be omitted.

The layout form of the pixel area, the structure of the thin film transistor, and the shape of the pixel electrode described above are just examples. The present disclosure is not limited thereto and may be variously modified.

The common electrode 270 is positioned on the pixel electrode 191 so as to be spaced apart from the pixel electrode 191 by a predetermined distance. A microcavity 305 is formed between the pixel electrode 191 and the common electrode 270. That is, the microcavity 305 is surrounded by the pixel electrode 191 and the common electrode 270. The width and area of the microcavity 305 may be variously modified according to the size and resolution of the display device.

The common electrode 270 may be made of a transparent metal material such as indium tin oxide (ITO) and indium zinc oxide (IZO). A predetermined voltage may be applied to the common electrode 270 so that an electric field may be generated between the pixel electrode 191 and the common electrode 270.

A first alignment layer 11 is formed on the pixel electrode 191. The first alignment layer 11 may also be formed directly on the first insulating layer 240 where it is not covered by the pixel electrode 191.

A second alignment layer 21 is formed below the common electrode 270 so as to face the first alignment layer 11.

The first alignment layer 11 and the second alignment layer 21 may be formed by vertical alignment layers, and made of alignment materials such as polyamic acid, polysiloxane, and polyimide. The first and second alignment layers 11 and 21 may be connected to each other at the edge of the pixel area PX.

A liquid crystal layer configured by liquid crystal molecules 310 is formed in the microcavity 305 positioned between the pixel electrode 191 and the common electrode 270. The liquid crystal molecules 310 may have negative dielectric anisotropy, which means they may stand up in a vertical direction to the substrate 110 when no electric field is applied. That is, the liquid crystal molecules 310 may be vertically aligned.

The first subpixel electrode 191h and the second subpixel electrode 191l to which the data voltages are applied generate an electric field together with the common electrode 270 to determine directions of the liquid crystal molecules 310 positioned in the microcavity 305 between the two electrodes 191 and 270. Luminance of light passing through the liquid crystal layer varies according to the directions of the liquid crystal molecules 310 determined above.

A second insulating layer 350 may be further formed on the common electrode 270. The second insulating layer 350 may be made of an inorganic insulating material such as silicon nitride (SiNx), silicon oxide (SiOx), and silicon oxynitride (SiOxNy), and may be omitted in some cases.

A color filter 230 is formed on the second insulating layer 350. The microcavity 305 and a connection microcavity 306 are formed below the color filter 230, and shapes of the microcavity 305 and the connection microcavity 306 may be maintained. That is, the color filter 230 is formed to be spaced apart from the pixel electrode 191 with the microcavity 305 therebetween.

The color filter 230 may display one of the primary colors such as three primary colors of red, green and blue. The color filter 230 is not limited to the three primary colors of red, green and blue and may also display one of cyan, magenta, yellow, and white-based colors.

The color filter 230 is formed in each pixel area PX and the second valley V2 along a pixel row, but is not formed in the first valley V1. The microcavity 305 is positioned below each color filter 230 in each of the first subpixel area PXa and the second subpixel area PXb. In the second valley V2, the microcavity 305 is not formed below the color filter 230. Instead, the partition wall 330 is formed below the color filter 230 in the second valley V2.

The partition wall 330 separates adjacent microcavities in the column direction from each other and supports the upper color filter 230. Further, the partition wall 330 also performs a function of the light blocking member, and as a result, formation of the light blocking member in the second valley V2 may be omitted.

Referring to FIG. 3, the partition wall 330 is formed by filling all the spaces between the adjacent microcavities 305 in the column direction. A height of the partition wall 330 may be the same as that of the microcavity 305. The partition wall 330 may be formed by modifying a part of a sacrificial layer 300 coated in a forming step of the microcavity, and the height of the partition wall 330 may be the same as the height of the microcavity. That is, the microcavity 305 and the partition wall 330 may be formed by the same process.

The partition wall 330 may be formed by curing the sacrificial layer 300 that is coated when the microcavity 305 is formed. The partition wall 330 may be a negative photoresist. That is, the partition wall 330 may be formed by curing the negative photoresist using light.

For example, according to an embodiment, after coating the negative photoresist which is a sacrificial layer material on the entire surface of the substrate during the forming process of the display device, the partition wall 330 is formed by exposing and curing only the region where the partition wall 330 is to be formed.

However, the partition wall 330 may be made of a different material. When the partition wall 330 is made of a positive photoresist, the exposed region may be a display area in which the partition wall is not formed.

The microcavity 305 is formed between the partition walls 330. In one pixel electrode, the partition walls 330 positioned at opposite sides along adjacent second valleys V2 and the upper color filter layer 230 form the microcavity.

On the partition wall 330, the common electrode 270, the second insulating layer 350, and the like are formed, and the partition wall 330 performs a function of supporting the color filter 230 formed above by filling the space of the second valley V2.

When the partition wall 300 does not exist, the upper color filter 230 may sag in the second valley V2. To prevent sagging, in the display device according to an exemplary embodiment of the present disclosure, the partition wall 330 exists in the second valley to planarize a surface where the color filter 230 is to be formed, thereby preventing sagging of the color filter 230.

An injection hole 307 exposing a part of the microcavity 305 is formed in the common electrode 270, the second insulating layer 350, and the color filter 230. The injection holes 307 may be formed to face each other at the edges of the first subpixel area PXa and the second subpixel area PXb along the first valley V1. That is, the injection holes 307 may be formed to correspond to the lower side of the first subpixel area PXa and the upper side of the second subpixel area PXb so as to expose the side of the microcavity 305. Since the microcavity 305 is exposed by the injection holes 307, an aligning agent, a liquid crystal material, or the like may be injected into the microcavity 305 through the injection holes 307.

A third insulating layer 370 may be further formed on the color filter 230. The third insulating layer 370 may be made of an inorganic insulating material such as silicon nitride (SiNx), silicon oxide (SiOx), and silicon oxynitride (SiOxNy). The third insulating layer 370 may be formed to cover an upper surface and a side of the color filter 230. The third insulating layer 370 serves to protect the color filter 230 made of an organic material.

The structure in which the third insulating layer 370 is formed on the color filter 230 is described above, but the present disclosure is not limited thereto, and the third insulating layer 370 may be omitted.

An overcoat 390 may be formed on the third insulating layer 370. The overcoat 390 is formed to cover the injection holes 307 that would otherwise expose a part of the microcavity 305 to the outside. That is, the overcoat 390 seals the microcavity 305 so as to prevent the liquid crystal molecules 310 formed in the microcavity 305 from being discharged to the outside. Since the overcoat 390 contacts the liquid crystal molecules 310, the overcoat 390 may be made of a material that does not react with liquid crystal molecules 310. For example, the overcoat 390 may be made of parylene and the like.

The overcoat 390 may be formed to have multilayers such as two layers and three layers. The two layers may be made of different materials. The three layers may be formed such that materials of adjacent layers are different from each other. For example, the overcoat 390 may include a layer made of an organic insulating material and a layer made of an inorganic insulating material.

Although not illustrated, polarizers may be further formed on upper and lower surfaces of the display device. The polarizers may be configured by a first polarizer and a second polarizer. The first polarizer may be attached onto the lower surface of the substrate 110, and the second polarizer may be attached onto the overcoat 390.

As such, in a display device according to an exemplary embodiment of the present disclosure, a partition wall filling the second valley is formed between the plurality of microcavities adjacent in a row direction. The partition wall fills a groove in the second valley and serves to support the color filter formed at an upper portion above the second valley. Accordingly, the sagging of the color filter layer may be prevented. Further, since the color filter and the partition wall serve as a black matrix, a black matrix need not be formed in the second valley. The partition wall may be a cured negative photoresist.

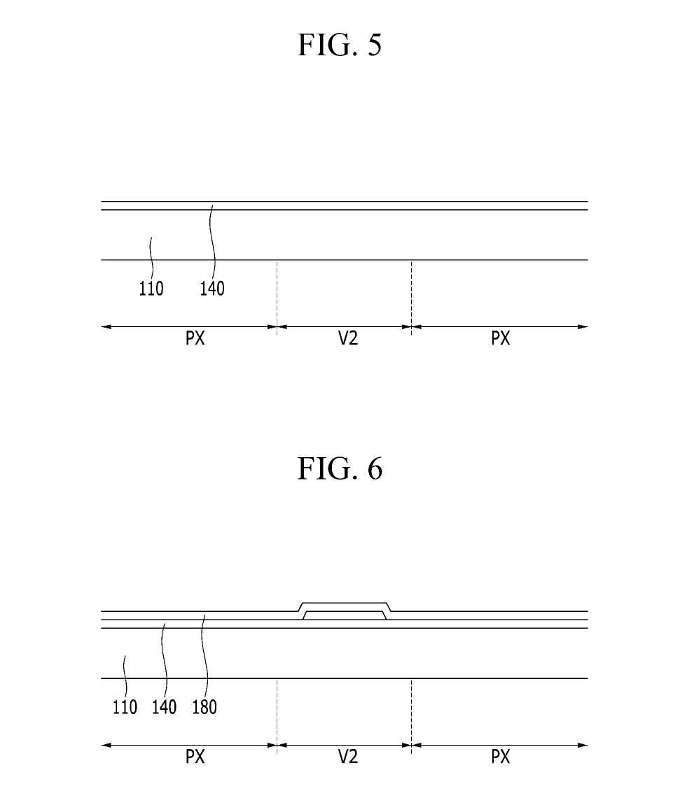

Next, hereinafter, a method for manufacturing the display device according to an exemplary embodiment of the present disclosure is described with reference to FIGS. 5 to 25. FIGS. 5 to 25 are process cross-sectional views illustrating a manufacturing process of the display device according to the exemplary embodiment of the present disclosure.

As illustrated in FIG. 5, on the substrate 110 made of glass or plastic, the gate line 121 and the step-down gate line 123 extending in one direction are formed, and the first gate electrode 124h, the second gate electrode 124l, and the third gate electrode 124c, which protrude from the gate line 121, are formed.

Further, the storage electrode line 131 may be formed together with but spaced apart from the gate line 121, the step-down gate line 123, and the first to third gate electrodes 124h, 124l, and 124c.

Next, the gate insulating layer 140 is formed on the entire surface of the substrate 110 including the gate line 121, the step-down gate line 123, the first to third gate electrodes 124h, 124l, and 124c, and the storage electrode line 131, by using an inorganic insulating material such as silicon oxide (SiOx) or silicon nitride (SiNx). The gate insulating layer 140 may be formed as a single layer or multilayers.

Next, the first semiconductor 154h, the second semiconductor 154l, and the third semiconductor 154c are formed by depositing and then patterning a semiconductor material such as amorphous silicon, polycrystalline silicon, and metal oxide on the gate insulating layer 140. The first semiconductor 154h may be formed to be positioned on the first gate electrode 124h, the second semiconductor 154l may be formed to be positioned on the second gate electrode 124l, and the third semiconductor 154c may be formed to be positioned on the third gate electrode 124c.

Next, referring to FIGS. 2 and 6, the data line 171 extending in another direction to cross the gate line 121 is formed by depositing and then patterning a metal material. The metal material may be formed as a single layer or multilayers.

Further, the first source electrode 173h protruding above the first gate electrode 124h from the data line 171, and the first drain electrode 175h spaced apart from the first source electrode 173h are formed together. Further, the second source electrode 173l connected with the first source electrode 173h, and the second drain electrode 175l spaced apart from the second source electrode 173l are formed together. Further, the third source electrode 173c extended from the second drain electrode 175l, and the third drain electrode 175c spaced apart from the third source electrode 173c are formed together.

The first to third semiconductors 154h, 154l, and 154c, the data line 171, the first to third source electrodes 173h, 173l, and 173c, and the first to third drain electrodes 175h, 175l, and 175c may be formed by sequentially depositing and simultaneously patterning a semiconductor material and a metal material. The first semiconductor 154h may extend to the lower portion of the data line 171.

The first/second/third gate electrodes 124h/124l/124c, the first/second/third source electrodes 173h/173l/173c, and the first/second/third drain electrodes 175h/175l/175c form first/second/third thin film transistors (TFTs) Qh/Ql/Qc together with the first/second/third semiconductors 154h/154l/154c, respectively. Next, the passivation layer 180 is formed on the data line 171, the first to third source electrodes 173h, 173l, and 173c, the first to third drain electrodes 175h, 175l, and 175c, and the semiconductors 154h, 154l, and 154c exposed between the respective source electrodes 173h/173l/173c and the respective drain electrodes 175h/175l/175c. The passivation layer 180 may be made of an organic insulating material or an inorganic insulating material, and may be formed as a single layer or multilayers.

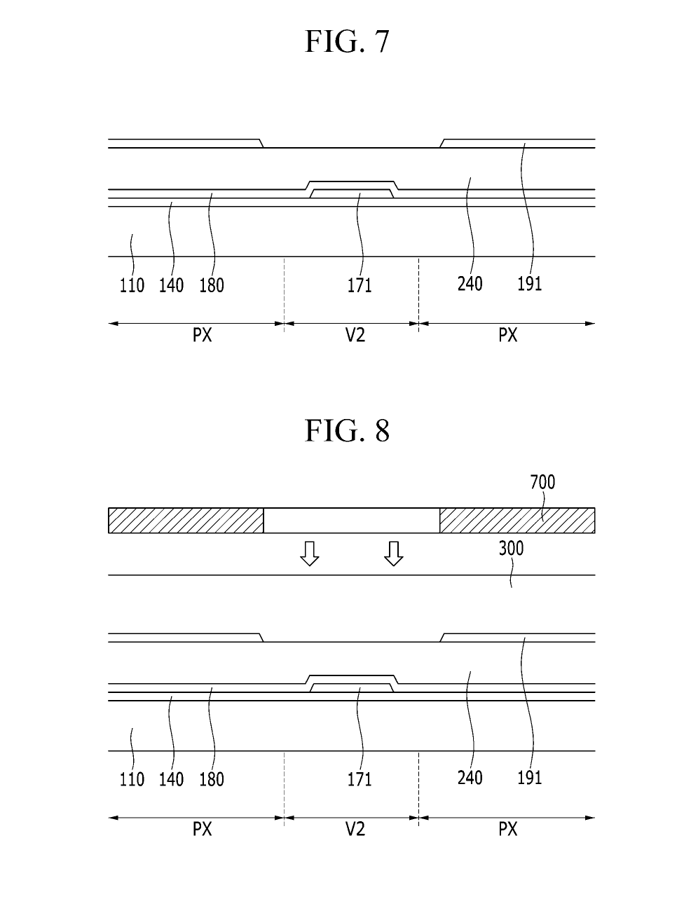

Next, the light blocking member 220 is formed on the thin film transistor of each pixel area PX on the passivation layer 180. That is, the light blocking member 220 is formed in the first valley where the thin film transistor is formed. However, in the second valley, which is a boundary of the pixel area, as illustrated in FIG. 7, the light blocking member 220 may not be formed. Since the structure formed on the second valley V2 serves as a light blocking member, formation of the light blocking member 220 in the second valley V2 may be omitted.

Next, referring to FIG. 7, the first insulating layer 240 made of an inorganic insulating material, such as silicon nitride (SiNx), silicon oxide (SiOx), and silicon oxynitride (SiOxNy), is formed on the light blocking member 220.

Next, by etching the passivation layer 180, the light blocking member 220, and the first insulating layer 240, a first contact hole 185h is formed to expose a part of the first drain electrode 175h, and a second contact hole 185l is formed to expose a part of the second drain electrode 175l.

Next, by depositing and then patterning a transparent metal material, such as indium tin oxide (ITO) and indium zinc oxide (IZO), on the first insulating layer 240, the first subpixel electrode 191h is formed in the pixel first subpixel area PXa, and the second subpixel electrode 191l is formed in second subpixel area PXb. The first subpixel electrode 191h and the second subpixel electrode 191l may be separated from each other with the first valley V1 therebetween. The first subpixel electrode 191h is connected to the first drain electrode 175h through the first contact hole 185h, and the second subpixel electrode 191l is connected to the second drain electrode 175l through the second contact hole 185l.

The horizontal stems 193h and 193l, and the vertical stems 192h and 1921l crossing the horizontal stems 193h and 193l are formed in the first subpixel electrode 191h and the second subpixel electrode 191l, respectively. Further, a plurality of minute branches 194h and 194l, which obliquely extend from the horizontal stems 193h and 193l and the vertical stems 192h and 192l, is formed.

Next, as illustrated in FIG. 8, the sacrificial layer 300 is formed by coating a photoresist on the pixel electrode 191. The photoresist may be a negative photoresist or a positive photoresist. In the case of the positive photoresist, a region to which light is irradiated is decomposed. In the case of the negative photoresist, the region to which light is irradiated is hardened by photo-curing.

As illustrated in FIG. 8, a mask 700 is positioned on the substrate coated with the photoresist. The mask 700 has an opening that transmits light only in a region where the partition wall 330 is to be formed. That is, the opening having a shape of the partition wall 330 is formed in the mask 700.

The opening of the mask 700 may be formed along the second valley, but not formed at a portion where the second valley V2 and the first valley V1 cross each other. That is, the opening of the mask 700 may formed along the second valley, but may be disconnected at the portion crossing the first valley.

The light is irradiated on the sacrificial layer 300 by using the mask 700.

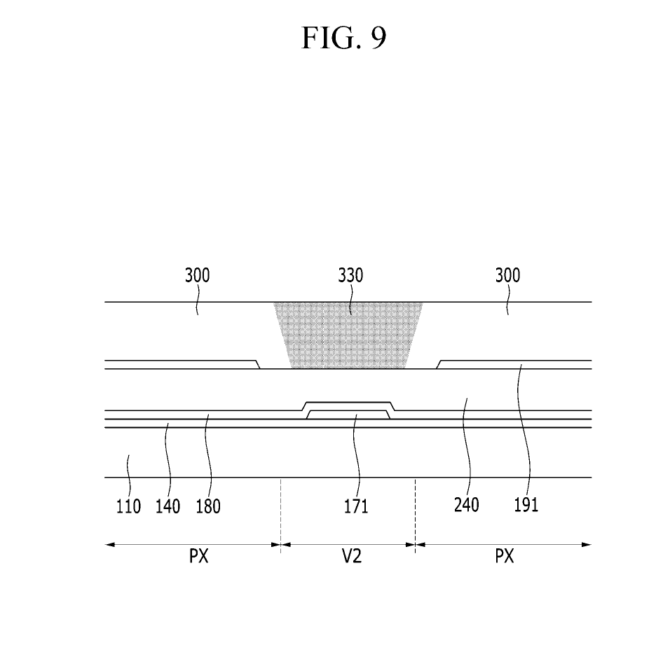

Next, as illustrated in FIG. 9, the negative photoresist of the sacrificial layer 300 corresponding to the opening of the mask 700 is cured to become the partition wall 330. That is, the sacrificial layer 300 in the second valley region exposed to the light has a different property from the sacrificial layer 300 that is not exposed to the light. Particularly, the negative photoresist material of the sacrificial layer 300 becomes cured and hardened by the light.

The sacrificial layer 300 that is not exposed to the light is removed in a subsequent step of removing the sacrificial layer. On the other hand, the sacrificial layer that is exposed to the light and cured is not removed in the subsequent step of removing the sacrificial layer, but exists as the partition wall 330.

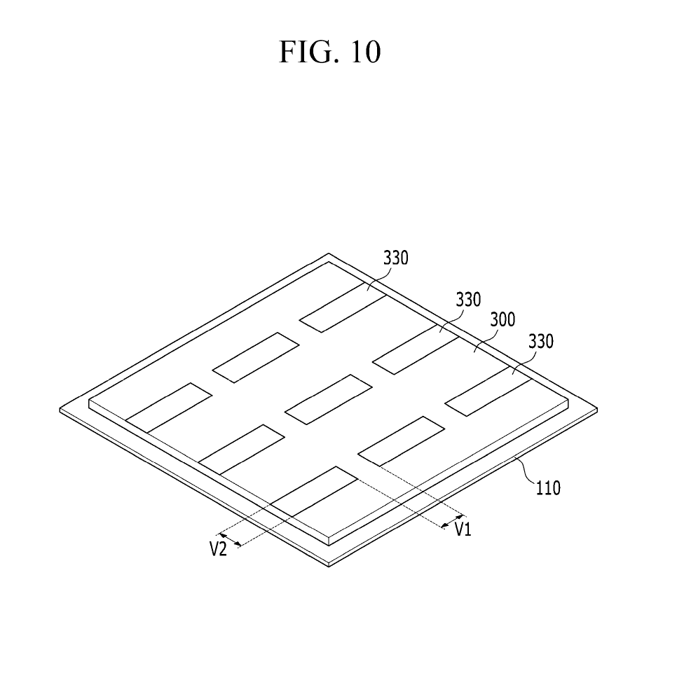

FIG. 10 illustrates the sacrificial layer 300 of the substrate after the step of FIG. 9. As illustrated in FIG. 10, the sacrificial layer 300 is coated on the entire surface of the substrate 110, and the sacrificial layer 300 corresponding to the second valley V2 is cured by exposure to light and changed into the partition wall 330. The partition wall 330 is formed along the second valley V2, but is not formed at a point crossing the first valley V1.

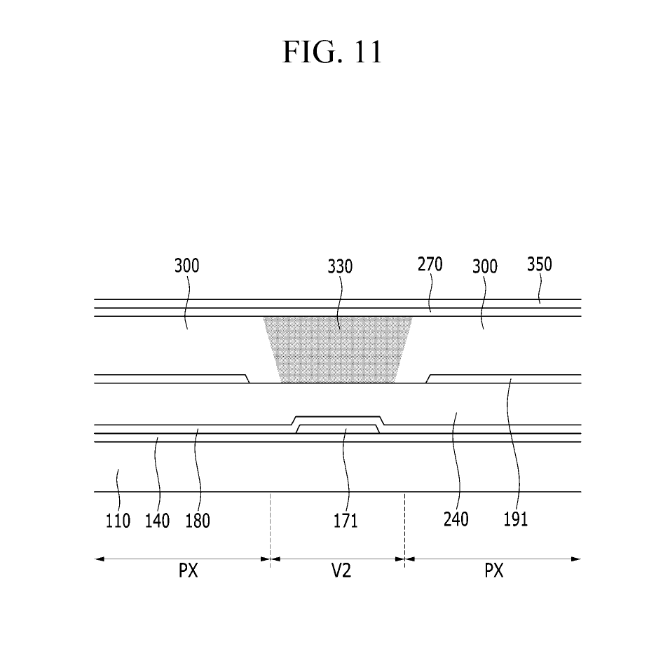

Next, as illustrated in FIG. 11, a transparent metal material, such as indium tin oxide (ITO) and indium zinc oxide (IZO), is deposited on the sacrificial layer 300 to form the common electrode 270.

Next, the second insulating layer 350 is formed on the common electrode 270 with an inorganic insulating material such as silicon nitride (SiNx), silicon oxide (SiOx), and silicon oxynitride (SiOxNy).

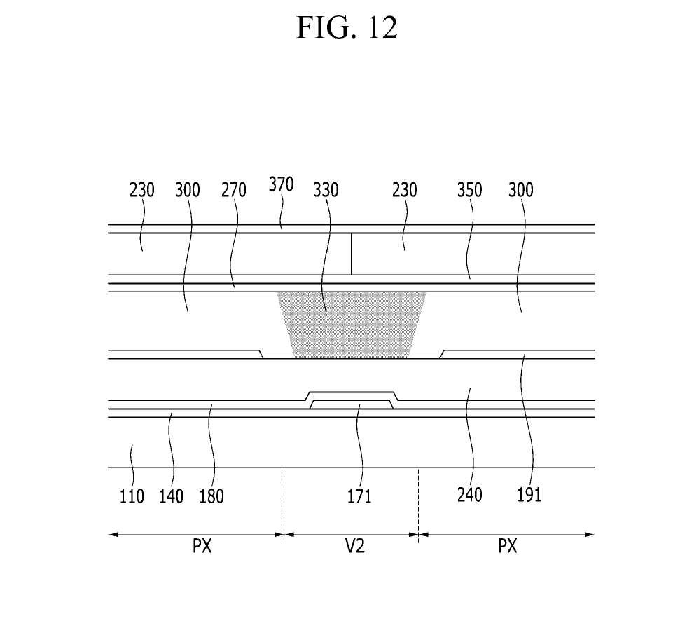

Next, as illustrated in FIG. 12, the color filter 230 is formed on the second insulating layer 350. Further, the color filters 230 having the same color may be formed in the column direction of the plurality of pixel areas PX. That is, the same color filter is formed in a vertical direction of the plurality of pixel areas PX, and color filters having different colors (e.g., RGB three colors) may be alternately formed in a horizontal direction.

As illustrated in FIG. 12, colors of left and right color filters 230 with respect to the second valley may be different from each other.

In the case of forming the color filters 230 having three colors, a first color filter 230 may be first formed, and then a second color filter 230 may be formed by shifting a mask. Next, the second color filter 230 may be formed, and then a third color filter may be formed by shifting the mask.

Next, a third insulating layer 370 may be formed on the color filter 230 with an inorganic insulating material such as silicon nitride (SiNx) and silicon oxide (SiOx). The third insulating layer 370 is formed on the patterned color filter 230 to cover and protect the side of the color filter 230.

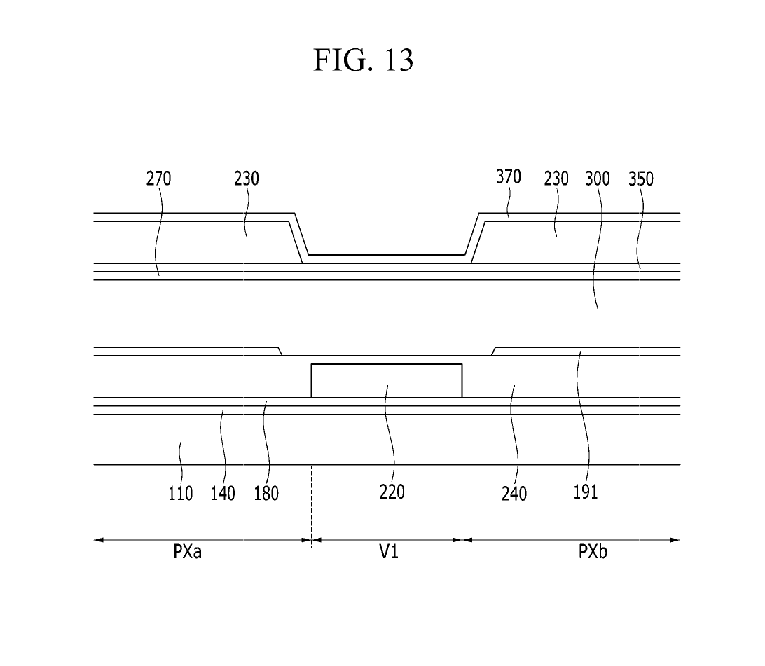

FIG. 13 illustrates another cross section of the display device manufactured up to the steps of FIG. 12. FIG. 13 illustrates a region traversing the first valley V1 region, similar to the cross-sectional view of FIG. 4. FIG. 12 illustrates a cross section traversing the second valley V2 region. Hereinafter, for convenience of description, the cross section traversing the first valley V1 region is described.

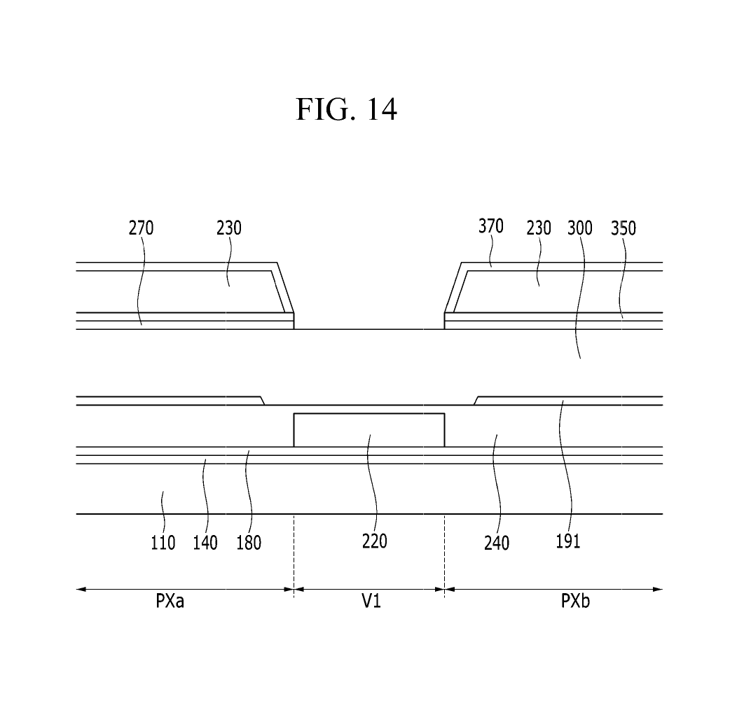

Next, as illustrated in FIG. 14, the third insulating layer 370, the second insulating layer 350, and the common electrode 270 positioned in the first valley V1 are removed by patterning the third insulating layer 370, the second insulating layer 350, and the common electrode 270. The sacrificial layer 300 positioned in the first valley V1 is exposed by patterning the third insulating layer 370, the second insulating layer 350, and the common electrode 270.

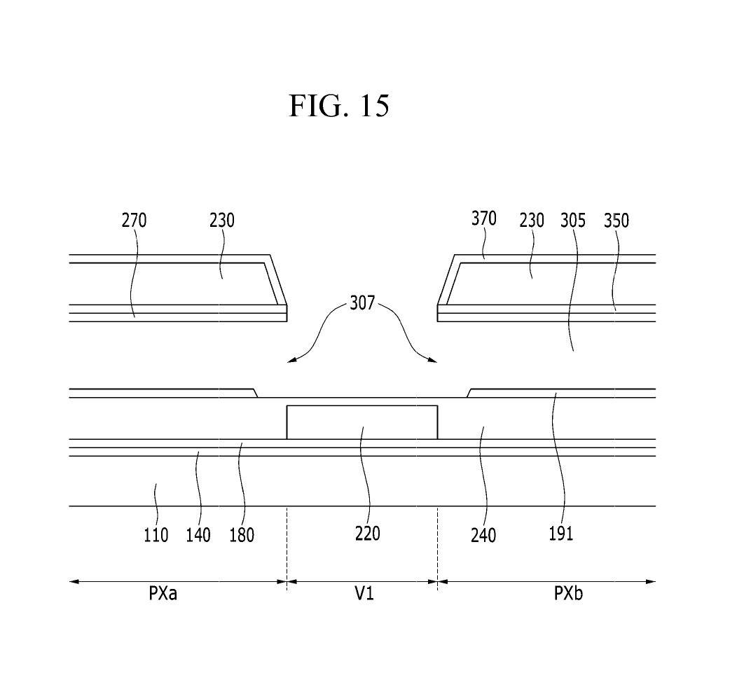

Next, referring to FIG. 15, the sacrificial layer 300 is fully removed through ashing by supplying oxygen plasma or a developer on the substrate 110 where the sacrificial layer 300 is exposed. When the sacrificial layer 300 is removed, the microcavity 305 is formed in the space where the sacrificial layer 300 used to be positioned.

As illustrated in FIG. 15, the pixel electrode 191 and the common electrode 270 are spaced apart from each other with the microcavity 305 therebetween, and the pixel electrode 191 and the color filter 230 are spaced apart from each other with the microcavity 305 therebetween. The common electrode 270 and the color filter layer 230 are formed to cover the upper surface and the two sides of the microcavity 305 along adjacent second valleys V2.

The microcavity 305 is exposed outside through a portion where the color filter layer 230 and the common electrode 270 are removed, which is called a liquid crystal injection hole 307. The liquid crystal injection hole 307 is formed along the first valley V1.

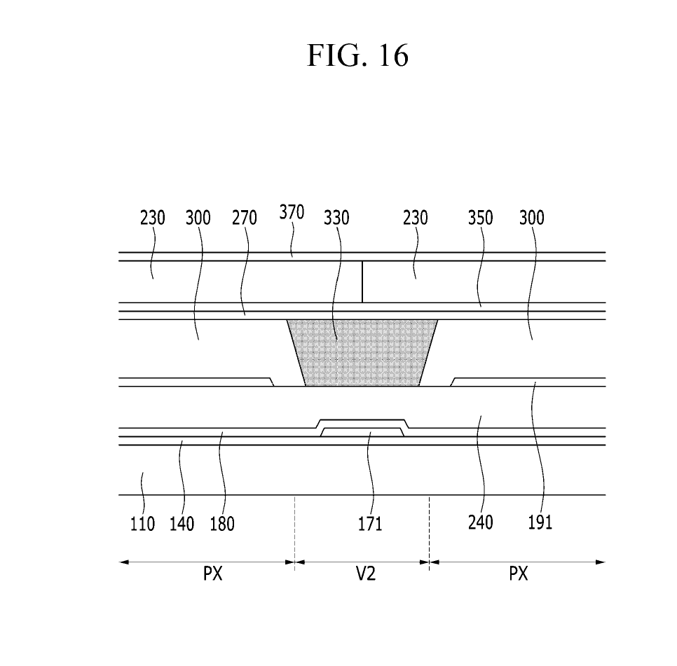

Referring to FIG. 16, in this step, although the sacrificial layer 300 is removed to form the microcavity 305, the partition wall 330 cured by photo-curing is not removed and remains after the removing process. That is, in the sacrificial layer, which is formed of the negative photoresist material, the partition wall 330 formation region is cured by exposure to light, and thus its strength is stronger. Accordingly, the portion of the sacrificial layer 300 that was photo-cured is not removed and remains after the removing process, and the remaining portion becomes the partition wall 330.

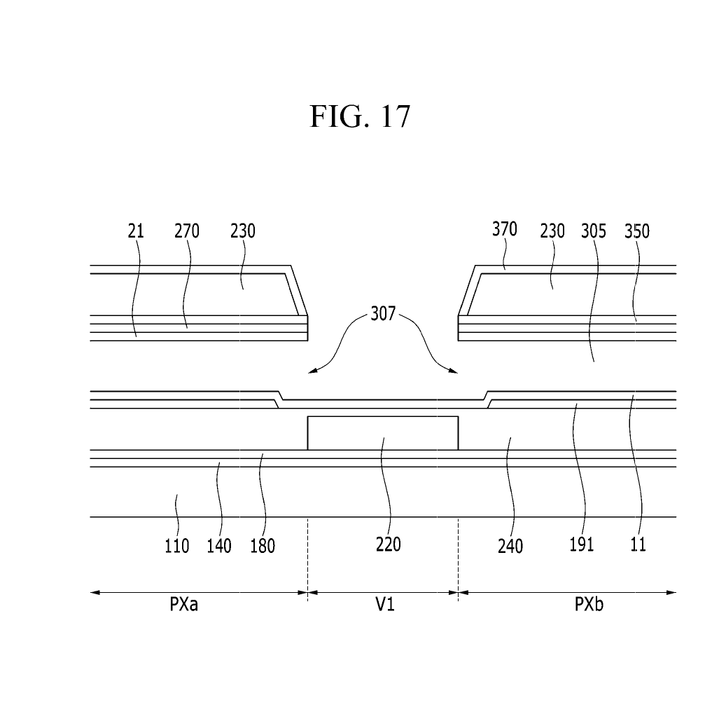

Next, referring to FIG. 17, when an aligning agent including an alignment material is dropped on the substrate 110 by a spin coating method or an inkjet method, the aligning agent is injected into the microcavity 305 through the injection hole 307. When the alignment agent is injected into the microcavity 305 and then a curing process is performed, a solution component is evaporated, and the alignment material remains on the inner wall of the microcavity 305.

Accordingly, the first alignment layer 11 may be formed on the pixel electrode 191, and the second alignment layer 21 may be formed below the common electrode 270. The first alignment layer 11 and the second alignment layer 21 are formed to face each other with the microcavity 305 therebetween and connected to each other at the edge of the pixel PX. Since the first alignment layer 11 and the second alignment layer 21 are connected to each other, they may be referred to as the same alignment layer.

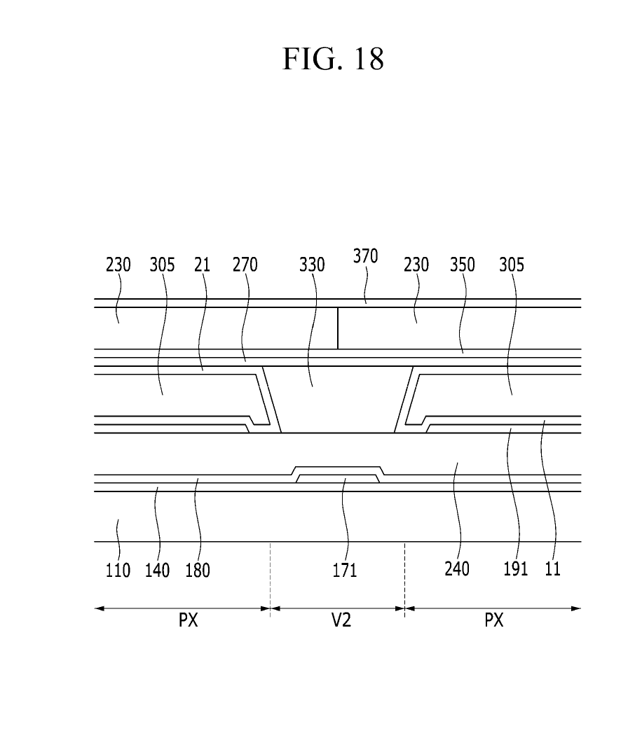

Similarly, referring to FIG. 18 which is the cross section in the second valley direction, the first alignment layer 11 and the second alignment layer 21 are connected to each other around the partition wall 330.

In this case, the first and second alignment layers 11 and 21 may be aligned in a vertical direction to the substrate 110, except for the side of the microcavity 305. In addition, by performing a process of irradiating UV rays to the first and second alignment layers 11 and 21, the first and second alignment layers 11 and 21 may be aligned in a horizontal direction to the substrate 110.

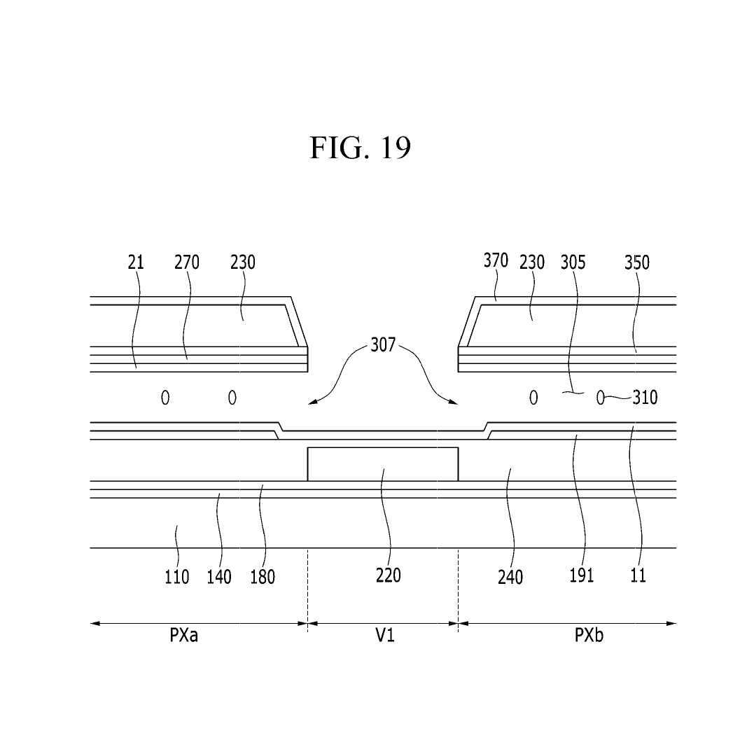

Next, referring to FIG. 19, when the liquid crystal material constituted by liquid crystal molecules 310 is dropped on the substrate 110 by an inkjet method or a dispensing method, the liquid crystal material is injected into the microcavity 305 through the injection hole 307. In this case, the liquid crystal material may be dropped in the injection holes 307 formed along the odd-numbered first valleys V1 and not dropped in the injection holes 307 formed along the even-numbered first valleys V1. In another case, the liquid crystal material may be dropped in the injection holes 307 formed along the even-numbered first valleys V1 and not dropped in the injection holes 307 formed along the odd-numbered first valleys V1.

When the liquid crystal material is dropped in the injection holes 307 formed along the odd-numbered first valleys V1, the liquid crystal material passes through the injection holes 307 by capillary force to be injected into the microcavity 305.

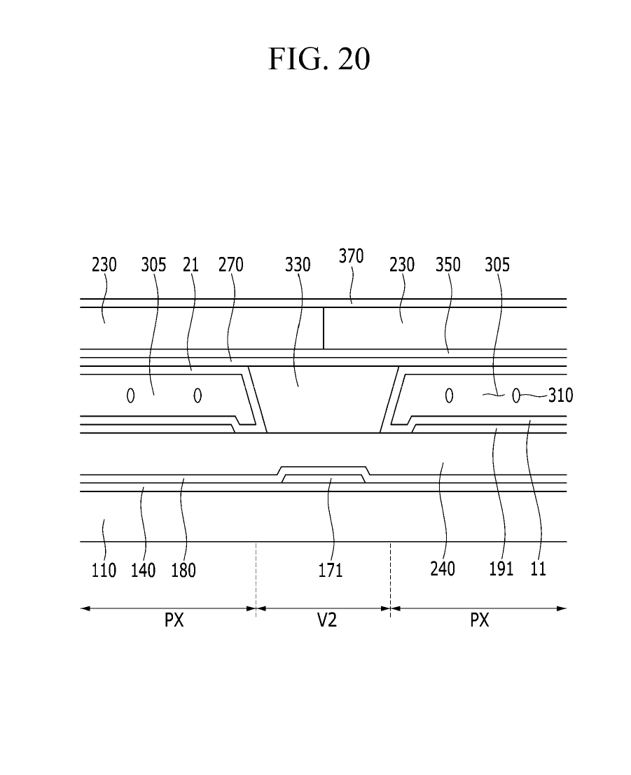

FIG. 20 illustrates that the liquid crystal material is injected at the cross section of the second valley direction.

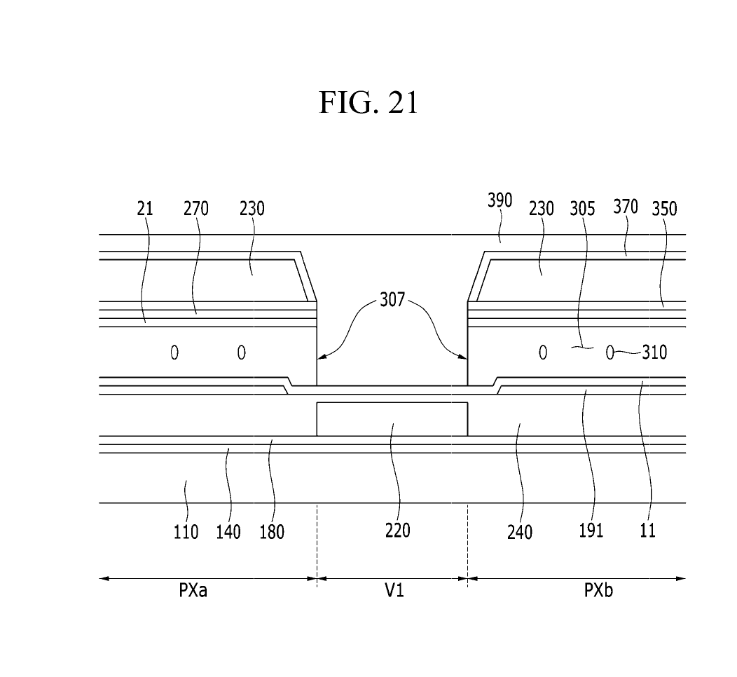

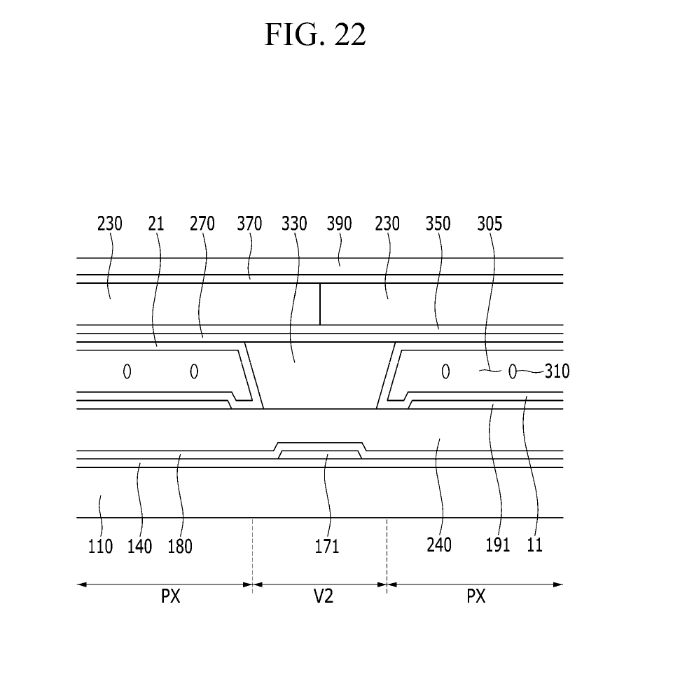

Next, as illustrated in FIGS. 21 and 22, the overcoat 390 is formed by depositing a material that does not react with the liquid crystal molecules 310 on the third insulating layer 370. The overcoat 390 is formed to cover the injection hole 307 where the microcavity 305 is exposed to the outside to seal the microcavity 305.

Next, although not illustrated, polarizers may be further attached onto the upper and lower surfaces of the display device. The polarizers may be configured by a first polarizer and a second polarizer. The first polarizer may be attached onto the lower surface of the substrate 110, and the second polarizer may be attached onto the overcoat 390.

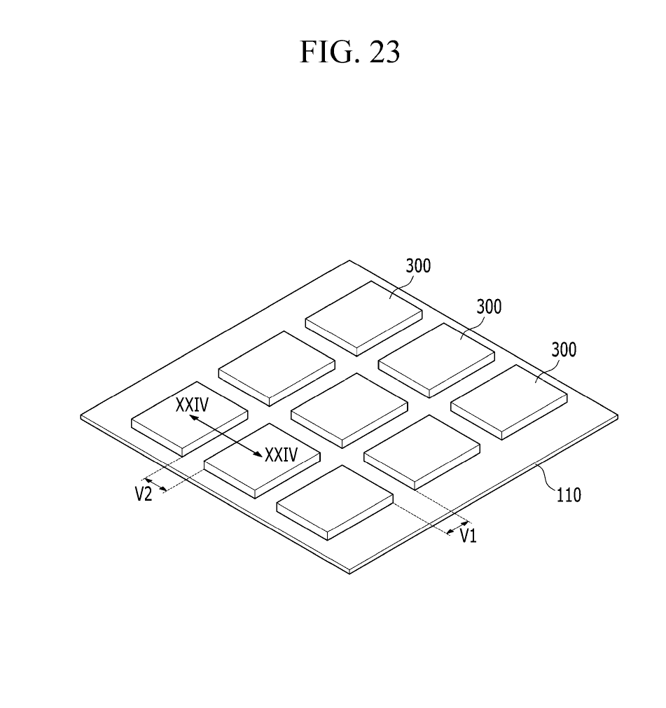

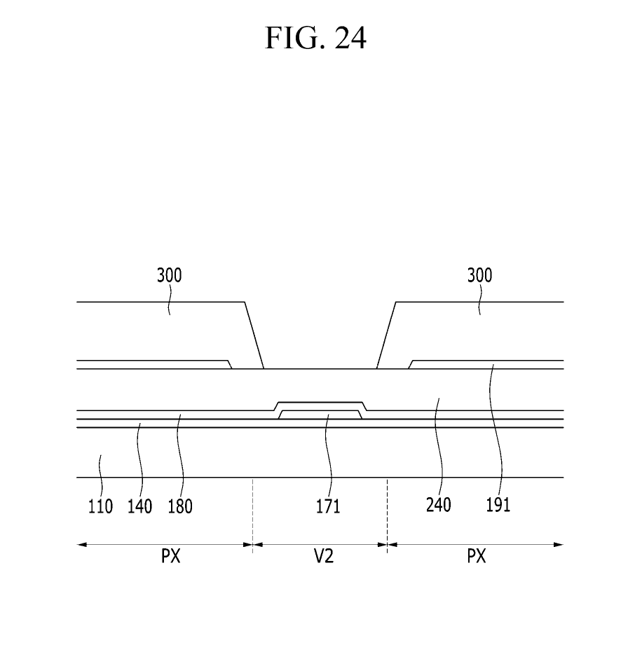

FIGS. 23 to 25 illustrate a liquid crystal display and a method for manufacturing the same according to a Comparative Example of the present disclosure. FIG. 23 illustrates a process of forming a sacrificial layer 300 in the liquid crystal display according to the Comparative Example. FIG. 24 is a cross-sectional view of FIG. 23 taken along line XXIV-XXIV.

The process before FIG. 23 is the same as the exemplary embodiment of the present disclosure described above. However, referring to FIG. 23, in the Comparative Example, the sacrificial layer is formed with the positive photoresist and coated on the entire surface of the substrate. Thereafter, the sacrificial layer 300 is removed from the first valley V1 and the second valley V2 by exposing the first valley and the second valley. Accordingly, referring to FIG. 23, the sacrificial layer 300 is formed in each pixel area.

Accordingly, referring to FIG. 24, the sacrificial layer 300 is not formed at the cross section in the second valley direction, and thus the step is generated.

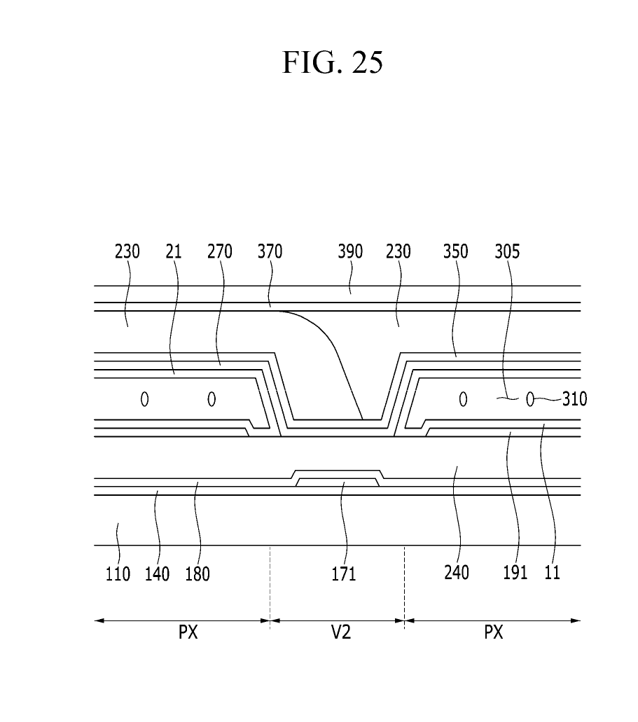

As a result, in a subsequent process, in order to maintain a structure of the color filter 230 and the like, as illustrated in FIG. 25, the color filter 230 fills the second valley V2 to serve as the partition wall.

When the color filter 230 fills the second valley V2, the structural stability of the color filter 230 layer is not ensured, and the manufacturing process is complicated.

In contrast, in a display device according to an exemplary embodiment of the present disclosure, the sacrificial layer is formed with the negative photoresist, and the partition wall is formed by exposing the second valley region and curing the photoresist, thereby preventing the color filter layer from sagging in the second valley. Further, because both the microcavity and the partition wall are formed by a single process using the sacrificial layer, the manufacturing process is simplified.

While the present system and method have been described in connection with exemplary embodiments, the present system and method are not limited to the disclosed embodiments. On the contrary, the present system and method cover various modifications and equivalent arrangements included within the spirit and scope of the appended claims.

<Description of symbols>

| 11: First alignment layer | 21: Second alignment layer |
|---|---|
| 110: Substrate | |
| 121: Gate line | 123: Step-down gate line |
| 124h: First gate electrode | 124l: Second gate electrode |
| 124c: Third gate electrode | 131: Storage electrode line |
| 140: Gate insulating layer | 154h: First semiconductor |
| 154l: Second semiconductor | 154c: Third semiconductor |
| 171: Data line | 173h: First source electrode |
| 173l: Second source electrode 173c: Third source electrode | |
| 175h: First drain electrode | 175l: Second drain electrode |
| 175c: Third drain electrode | 180: Passivation layer |
| 191: Pixel electrode | 191h: First subpixel electrode |
| 191l: Second subpixel electrode | 220: Light blocking member |
| 230: Color filter | 240: First insulating layer |
| 270: Common electrode | 300: Sacrificial layer |
| 305: Microcavity | 330: Partition wall |
| 307: Injection hole | 310: Liquid crystal molecule |
| 350: Second insulating layer | 370: Third insulating layer |
| 390: Overcoat | 700: Mask |

What is claimed is:

1. A display device comprising:
a substrate;
a plurality of thin film transistors positioned on the substrate;
a plurality of pixel electrodes connected with one terminal of the thin film transistor;
a plurality of partition walls formed between the plurality of pixel electrodes;
a liquid crystal material positioned in a microcavity between adjacent partition walls;
a common electrode positioned on the partition wall and the liquid crystal material; and
a color filter layer formed on the common electrode,
wherein the partition wall is a photoresist.

2. The display device of claim 1, wherein:
the partition wall is a cured negative photoresist.

3. The display device of claim 1, wherein:
a plurality of microcavities is arranged in a matrix form on the substrate, and
the plurality of microcavities are spaced apart from each other with a first valley formed in an extending direction of the gate line and a second valley formed in an extending direction of the data line therebetween.

4. The display device of claim 3, wherein:
the partition wall fills the second valley.

5. The display device of claim 3, wherein:
the partition wall is not formed in the first valley.

6. The display device of claim 3, wherein:
a thin film transistor is formed in the first valley, and
a light-blocking black matrix is formed in the first valley.

7. The display device of claim 4, wherein:
a color filter layer is positioned on the partition wall.

8. The display device of claim 7, wherein:
two color filters having different colors are formed to be adjacent to each other on the partition wall.

9. The display device of claim 1, wherein:
the height of the partition wall is the same as that of the microcavity.

10. The display device of claim 1, wherein:
a common electrode is formed below the color filter layer, and
the common electrode is spaced apart from the pixel electrode with the microcavity therebetween.

11. A method for manufacturing a display device, comprising:
forming a thin film transistor on a substrate;
forming a first insulating layer on the thin film transistor;
forming a pixel electrode connected with the thin film transistor on the first insulating layer;
forming a sacrificial layer by coating a photoresist on the pixel electrode;
curing a partial region of the sacrificial layer by positioning and exposing a mask on the sacrificial layer;
forming a color filter layer on the sacrificial layer;
forming a liquid crystal injection hole and exposing the sacrificial layer by patterning the color filter layer;
forming a microcavity between the pixel electrode and the color filter layer by removing the sacrificial layer;
forming an alignment layer by injecting an alignment layer material into the microcavity;
forming a liquid crystal layer by injecting a liquid crystal material into the microcavity; and
sealing the microcavity by forming an overcoat on the color filter layer.

12. The method of claim 11, wherein:
the photoresist used in the forming of the sacrificial layer by coating the photoresist on the pixel electrode is a negative photoresist.

13. The method of claim 11, wherein:
in the curing the partial region of the sacrificial layer by positioning and exposing the mask on the sacrificial layer,
the negative photoresist is cured to form the partition wall.

14. The method of claim 13, wherein:
a plurality of microcavities is arranged in a matrix form on the substrate, and
the plurality of microcavities are spaced apart from each other with a first valley formed in an extending direction of the gate line and a second valley formed in an extending direction of the data line therebetween.

15. The method of claim 14, wherein:
the partition wall fills the second valley.

16. The method of claim 11, wherein:
in the forming the microcavity between the pixel electrode and the color filter layer by removing the sacrificial layer,
the partial region of sacrificial layer is not removed and remains as the partition wall.

17. The method of claim 11, further comprising:
between the curing of the partial region of the sacrificial layer by positioning and exposing the mask on the sacrificial layer and the forming of the color filter layer on the sacrificial layer,
forming a common electrode on the sacrificial layer.
